(19) United States
(12) Patent Application Publication
(10) Pub. No.: US 2016/0178819 A1
(43) Pub. Date: Jun. 23, 2016

(54) SELF-FILTERED OPTICAL MONITORING OF NARROW BANDPASS FILTERS

(71) Applicant: Veeco Instruments, Inc., Plainview, NY (US)

(72) Inventors: Ove Lyngnes, Fort Collins, CO (US); James D. Deakins, Fort Collins, CO (US)

(21) Appl. No.: 14/581,303

(22) Filed: Dec. 23, 2014

(51) Int. Cl. G02B 5/28

(52) U.S. Cl. CPC G02B 5/288

(57) ABSTRACT

A narrow band optical filter made by forming a set of layers on an initial optical filter, the set of layers being formed based on filtered feedback light from the initial optical filter. The set of layers can be formed by using an iterative, single wavelength turning point monitoring algorithm.

### BACKGROUND

Optical filters, which use the principle of interference, can be used to produce complex spectral responses and to adjust relative optical power among a plurality of different wavelength channels. To create a filter, alternating layers of an optical coating material are built up upon a substrate, selectively reinforcing the transmission or reflection of certain wavelengths of light and attenuating other wavelengths. By controlling the thickness and number of the layers, the frequency (or wavelength) band being passed by the filter (the bandpass of the filter) can be tuned and made as wide or as narrow as desired. Unwanted wavelengths are reflected or absorbed, depending on the materials used.

Narrow band or narrow bandpass optical systems have been developed for a wide variety of applications for many years. The usual objective is to isolate an optical signal of a specific wavelength in the presence of a large flux of noise, i.e. optical radiation at other wavelengths. A better signal to noise ratio can be derived from the detector if the signal is within a narrow band of the optical spectrum.

A common type of narrow bandpass filters is “cavity filters”. A cavity has two mirrors with a spacer layer between them; the spacer layer can be referred to as a cavity layer. The mirrors are formed by sequence of alternating coating layers. Typically, the thicknesses of the layers are picked to have an optical thickness equal to a quarter of the wavelength for which the filter is designed, which results in constructive interference between the reflections from the interfaces between the layers. The cavity layer typically has an optical thickness equal to an integer number of half the wavelength for which the filter is being designed. This results in destructive interference between the reflection of the two mirrors, which results in high transmission through the cavity filter at the design wavelength. Other wavelengths do not have destructive interference between the reflection of the two mirrors, leading to reflection of these wavelengths; i.e., these wavelengths are not transmitted through the filter.

High transmission of a cavity filter is depending on how well the reflection of the two mirrors cancel each other out at the design wavelength. It is critical to deposit both the mirror layers and the cavity spacer with the correct thickness of the layers. A common method of controlling the layer thicknesses during deposition is to monitor the optical transmission of the filter at the design wavelength and determine the stop point for the deposition of each layer based on the observed signal change. It has been found that so-called “turning point monitoring” works well for cavity filters as a large degree of error compensation in the layer thicknesses are achieved; see, for example, “Turning point monitoring of narrow-band all-dielectric thin-film optical filters,” H. A. Macleod, Optical Acta., vol. 19, No 1, 1972 pp 1-28. Using turning point monitoring, each layer ends at the point when the monitored signal ‘turns’ at either a maximum or a minimum.

The transmission shape of the optical filter, whether formed by turning point monitoring or not, can be enhanced by depositing multiple cavity filters on top of each other. By using numerical calculations to optimize the layers in the individual cavity filters and the number of cavity filters deposited, the resulting total filter can be designed to have the desired width and shape of the transmission band as well as the desired rejection of the blocked wavelengths.

### SUMMARY

Implementations described and claimed herein include a narrow bandpass optical filter made by forming a set of layers on an initial optical filter, the set of layers being formed based on filtered feedback light from the initial optical filter.

One particular implementation is a method of making a multi-cavity optical filter by monitoring feedback light filtered by an initially deposited first cavity to control the deposition of subsequent deposited cavities.

Another particular implementation is a method of making an optical filter by depositing a set of layers based on filtered feedback light from an initial deposited optical filter.

Yet another particular implementation is a method of making an optical filter, the method comprising depositing a first set of layers to form a first cavity, and depositing a second set of layers based on filtered feedback light from the first cavity to form a second cavity.

Yet another particular implementation is a method of making a narrow bandpass filter. This particular method comprises depositing a first dielectric layer on an initial optical filter, and monitoring a thickness of the first dielectric layer, and depositing a second dielectric layer on the first dielectric layer, and monitoring a thickness of the second dielectric layer. Both the first thickness and the second thickness are monitored by fitting the measured transmission to the function:

$$T ( t ) = \frac{To [ B - 1 ]}{[ B - cos ( piR ( t + t 0 ) ) ]}$$

where:

B is a fitting constant determining the amplitude of the transmission signal,

T₀ is the peak transmission,

R is the deposition rate in QWs/sec, and

t₀ is an offset factor.

Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTIONS OF THE DRAWING

FIG. 1A is a schematic rendering of the broadband spectrum of sunlight, and FIG. 1B is a schematic rendering of a narrow spectrum of the sunlight, after having been passed through a narrow bandpass optical filter.

FIG. 2 is a schematic top plan view of an example ion beam sputter deposition system suitable for making a narrow bandpass optical filter.

FIG. 3 is a schematic diagram of an optical monitor system operably connected to a deposition system.

FIG. 4 is a graphical comparison between a theoretical single wavelength monitoring transmission signal evolution and a theoretical 2 nm spectral width monitoring transmission signal evolution during the deposition of individual layers of a three-cavity 0.6 nm FWHM bandpass filter, as prepared by the methods of the present disclosure.

FIG. 5 is a graphical comparison of the theoretical transmission to the actual transmission for a narrow bandpass filter prepared in the present disclosure.

### DETAILED DESCRIPTION

The present disclosure is directed to methods of making a narrow band optical filter by forming a multi cavity filter using filtered light from the first cavity to monitor and control the formation of subsequent deposited cavity filters. The present disclosure provides a process that enables control of the deposition of narrow band optical filters using single wavelength optical monitoring (e.g., turning point monitoring) even if the filter transmission peak is not spectrally resolved by the optical monitoring system, such as with a CCD based optical monitoring system (OMS) with limited spectral resolution. The process also compensates for drifts in spectral centering between different cavities of the filter during deposition, enabling higher production yields and higher peak transmission.

The disclosure is also directed to methods of making a multi-cavity, narrow bandpass optical filter by using the first cavity of the filter to narrow the band of the light used to monitor and control the deposition of the subsequent cavity. Additional cavities are formed by using all of the previously formed cavities to filter the light.

In the following description, reference is made to the accompanying drawing that forms a part hereof and in which are shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

In some instances, a reference numeral may have an associated sub-label consisting of a lower-case letter to denote one of multiple similar components. When reference is made to a reference numeral without specification of a sub-label, the reference is intended to refer to all such multiple similar components.

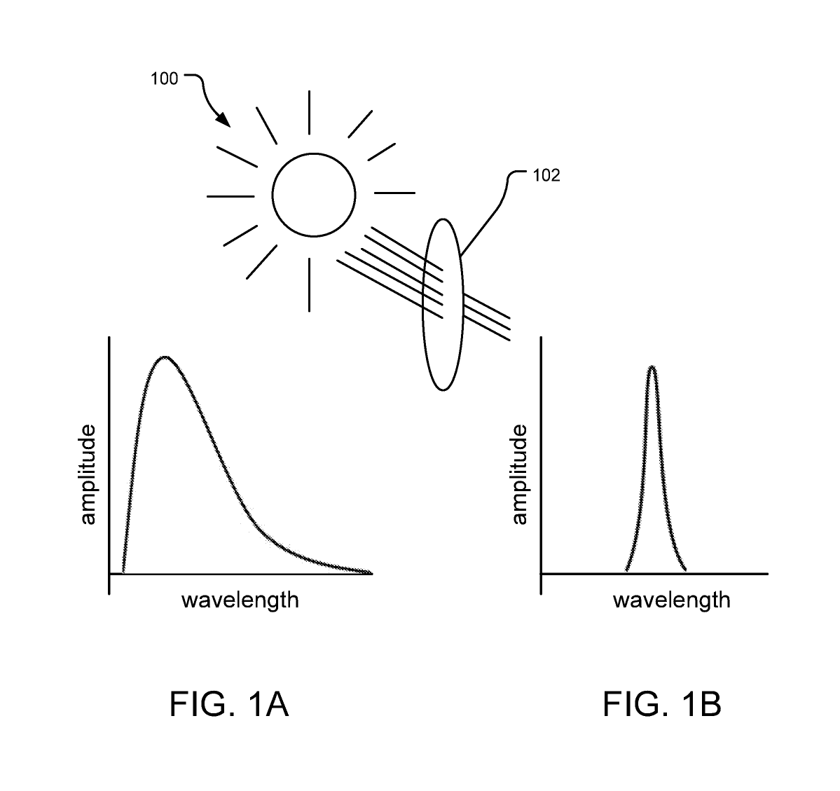

FIGS. 1A and 1B schematically and generically illustrate the effect of a narrow bandpass filter on a light source, in this particular figure, on sunlight. The sun 100, and other light sources (e.g., a light bulb) produce light having a distribution of wavelengths, only some of which are visible to the human eye. FIG. 1A is a schematic rendering of the broadband spectrum of sunlight. When the sunlight is passed through a narrow bandpass optical filter 102, the filter only passes the desired wavelengths and blocks or otherwise interferes with the undesired wavelengths. The filter 102 can be made to pass as wide or as narrow of a spectrum of wavelengths as desired. FIG. 1B is a schematic rendering of a narrow spectrum of the sunlight, after having been passed through the narrow bandpass optical filter 102.

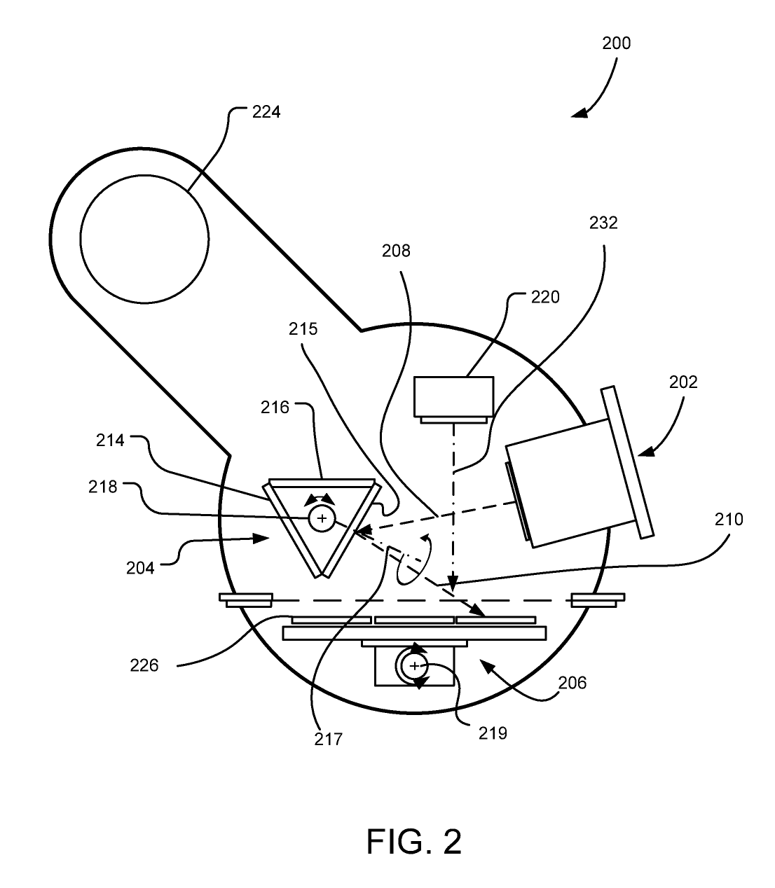

FIG. 2 illustrates an example implementation of an ion beam system for creating narrow bandpass filters of this disclosure. Of course, other deposition or coating systems, including thermal evaporators, electron beam evaporators, ion assisted electron beam evaporators and magnetron sputtering systems could be used in place of an ion beam system.

Specifically, FIG. 2 illustrates a top-down view of a dual ion beam system 200. The ion beam system 200 includes a first RF ion source 202, a target assembly 204, and a substrate assembly 206. The first RF ion-source 202, generates an ion-beam 208 that is directed towards the target assembly 204. The target assembly 204, upon interaction with the ion-beam 208, generates a sputter plume 210 that is used for deposition on a substrate 226 of the substrate assembly 206.

The target assembly 204 includes a plurality of target surfaces 214, 215, 216. In one implementation of the ion beam system 200, the target assembly 204 is designed to allow the target surfaces 214, 215, 216 to index around an axis 218 to change from one target 215 to another target 214 or target 216. In one implementation of the ion beam system 200, each of the target surfaces 214, 215, 216 has a different material on its surface. The angle of the active target surface, e.g., target surface 215, can be changed to an alternate static angle relative to the ion beam 208 during deposition. Alternatively, the angle of the active target surface, e.g., target surface 215, can be oscillated over a range of angles during deposition to help distribute wear across the target surface and to improve deposition uniformity. In an alternate implementation, the target surface 215 may also be rotated around an axis 217.

A second RF ion-source 220 can be provided to assist the deposition of the sputter plume 210 on the substrate 226. In one implementation of the ion beam system 200, a gating mechanism (not shown) is used to manage the amount and location of the deposition of the sputter plume 210 on the substrate 226. In one example implementation, the second ion source 220 generates an ion beam 232 that is directed toward the substrate assembly 206. Such an assisting ion beam 232 may be used to either pre-clean or pre-heat the surface of the substrate 226. In an alternate implementation, the assisting ion beam 232 is used in combination with material from sputter plume 210 to enhance the surface film deposition kinetics (i.e., material deposition, surface smoothing, internal stress, oxidation, nitridation, etc.) on substrate 226. In an alternate implementation, the assisting ion beam 232 is used to make deposition of sputter material more dense (or packed) and/or to make the deposition surface smoother.

An implementation of the ion beam system 200 is provided with a vacuum system plenum 224 to generate vacuum condition inside the ion beam system 200. The substrate assembly 206 may be provided with a rotating mechanism to effectively generate a single axis rotation or a planetary-motion of substrate 226. The substrate assembly 206 may also be tilted to alternate angles around the axis 219 either statically or dynamically during deposition in order to improve deposition thickness uniformity across the substrate 226. In an alternative implementation, the deposition thickness uniformity across the substrate 226 can be further improved by a static or movable mechanical shadow masks. In the case of a movable mask, different masks optimized for a particular sputtering target 214, 215, 216 are moved into place when that particular target is used.

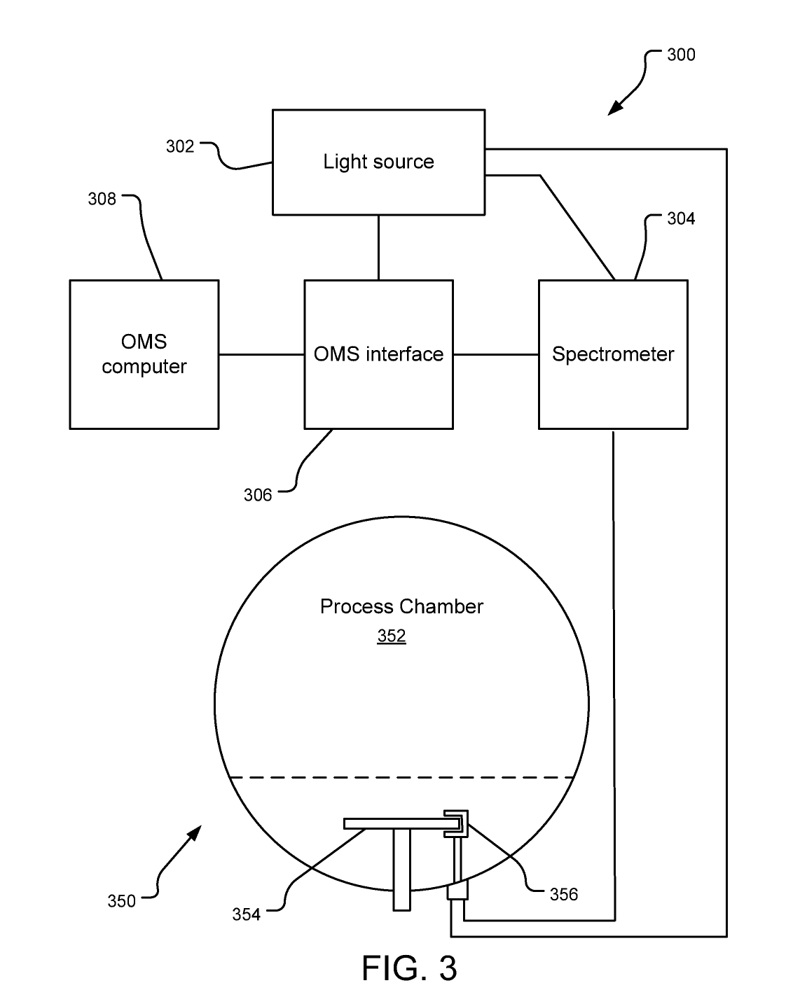

FIG. 3 schematically illustrates an optical monitor system (OMS) 300 installed with a deposition system 350. The monitoring system 300 includes a light source 302, a spectrometer 304 (or an optical filter), an electronics interface 306 and a control computer 308. In one implementation, the light source 302 is a white light source such as an incandescent lamp. In another implementation, the light source 302 is a narrow wavelength source such as a laser source. In yet another implementation, the light source 302 is a filtered broadband source such as an incandescent lamp in combination with a narrow band optical filter.

The light from the light source 302 is directed into a process chamber 352 of the deposition system 350 and onto a monitoring substrate 354 so that the optical transmission or reflection from the monitoring substrate 354 can be monitored during the deposition of an optical coating by deposition system 350.

The reflected or transmitted light is collected from substrate 354 and directed to the spectrometer/filter 304. In one implementation, the light is directed with the aid of optical fibers to and from a caliper 356 that aligns the light through the monitoring substrate 354. In another implementation, the light is directed using free space optics consisting of lenses, mirrors, and optical windows.

The light from the monitoring substrate 354 is analyzed by the spectrometer/filter 304, for example, in combination with an optical detector. In one implementation, the spectrometer 304 is a monochromator that filters only a near single wavelength of light to the detector. In another implementation, the spectrometer 304 is a multi-wavelength spectrometer that capture a broad spectrum onto a CCD array detector. In yet another implementation, the spectrometer 304 is replaced with an optical interference filter that selects the wavelength reaching the detector.

The signal from the spectrometer 304 is passed to the OMS electronics interface 306 that converts the signal to a digital signal to be analyzed by the OMS computer 308 incorporating software to analyze the signal and fit it to numerical models of the signal evolution with coating deposition. The OMS electronics interface 306 can also control the light source. In one implementation, the OMS electronic interface 306 combines the signal with an electronic trigger signal that is synchronized to the fixture rotation, so that the signal is only collected for the point on the fixture where the optical monitoring substrate 354 is mounted.

The ion beam system 200 of FIG. 2, or the monitoring system 300 and deposition system 350 of FIG. 3, or another system or process, is used to form a cavity filter, such as a multiple cavity optical filter. As indicated above, in accordance with this disclosure, a first cavity filter (e.g., which may be a deposited cavity filter) is used to filter the light of an optical monitoring system, which is used to control the layer thickness of subsequent deposited cavity filters. The first filter may be formed by the ion beam system 200 or by some other mechanism.

A cavity filter (such as that formed by the ion beam system 200) has two reflectors made from quarter-wave stacks separated by a half wave (or multiple half wave) dielectric layers. Optical filters having a relatively simple band-pass or band-reject spectral response can be constructed by depositing alternating layers of two dielectric materials that differ in refractive index on a substrate (e.g., a transparent substrate). One of the dielectric materials is distinguished as a high index material, and the other dielectric material is distinguished as a low index material. To form a multiple cavity or multi-cavity filter, a cavity is deposited on top of another cavity, and so forth, with a quarter-wave layer of low index material between. The specific material, thickness of each layer, and number of layers defines the slopes of the filter transmission response.

Typically, the material layers are deposited on a substrate (e.g., substrate 226) that is transparent over the wavelength of interest and, may be made from a wide variety of materials including (but not limited to), glass, quartz, clear plastic, silicon, and germanium. Usually, the dielectric materials used for the quarter and half-wave layers have indices of refraction in the range 1.3 to beyond 4.0. For example, some suitable materials are magnesium fluoride (1.38), thorium fluoride (1.47), cryolite (1.35), silicon dioxide (1.46), aluminum oxide or alumina (1.63), hafnium oxide or hafnia (1.85), tantalum pentoxide (2.05), niobium oxide (2.19), zinc sulphide (2.27), titanium oxide or titania (2.37), silicon (3.5), germanium (4.0), and lead telluride (5.0).

To properly form the cavities, the thicknesses of the alternating layers must be exact or close to exact. A manufacturing technique known as “turning point monitoring” can be used to determine when to switch from one layer material to the other material. “Turning point monitoring” requires each of the alternating layers to have a physical thickness equal to an integer multiple of a one-quarter-wavelength travel of a narrow band monitoring light beam as transmitted through the layers. The alternating layers have the same, or an integer multiple of the same, optical thickness but have physical thicknesses that differ because of differing refractive indices. The film thickness corresponding to a quarter-wavelength travel of the monitoring beam (i.e., quarter-wave optical thickness) is calculated as one-quarter of the wavelength of the monitoring beam in a vacuum divided by the refractive index of the layer material in which the beam is transmitted.

Design of the filter can be made, for example, using commercially available computer programs, where the spectral response of a stack of alternating high and low index layers (i.e., a filter design) is calculated. The calculation is used to guide the selection of a design, which for a cavity design, typically consists of selecting the number of cavities, the number of layers in the mirror stacks, and the thickness of the cavity layers that result, in a spectral response that matches the required nominal center wavelength, bandwidth and steepness of transition of the filter.

The first filter, or first cavity, can be formed using standard optical monitoring techniques to form the layers. As each layer is deposited, multiple reflections of the monitoring light beam from each of the interfaces between the deposited layers produce interference effects that vary between points of maximum and minimum interference (i.e., local transmission extremes) at quarter-wavelength thicknesses of the layers. Deposition of one layer to the other is switched at turning points from one of the high or low index materials to the other as the appropriate transmission extremes are reached. These turning points or transmission extremes are seen as maxima or minima on a transmission graph. Subsequent filter cavities may be immediately formed on the first filter, or there may be a delay in forming the subsequent cavities.

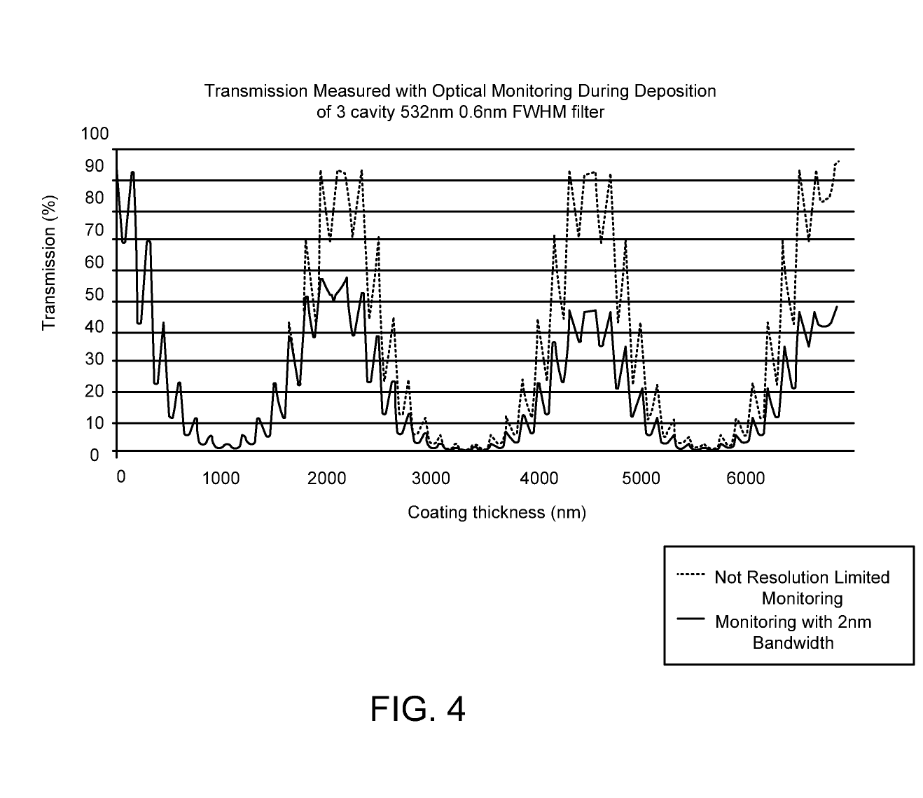

In the prior art, turning point monitoring must use light that has a spectral width narrower than the spectral width of the deposited filter, i.e., monitoring is not resolution limited. This is achieved by using a narrow bandwidth light source such as a laser or by filtering the monitored light with a monochromator or a previously manufactured optical filter. FIG. 4 shows the theoretical transmission in the case of monitoring which is not resolution limited. FIG. 4 also shows the transmission for the case if the deposited filter has a transmission spectral width that is wider than the transmission of the deposited filter. In this case, the monitoring signal starts to be spectrally filtered by the deposited filter as more coating layers are deposited. As a result, the monitoring signal deviates from the theoretically expected evolution during the deposition. Most importantly, the turning points will no longer correspond to the correct end points of each layer, leading to large thickness errors in the deposition.

In accordance with the invention of this disclosure, the output light signal, from the first filter, is monitored. The spectral width of this monitored signal is increased, for example, by adjusting the slit width on a monochromator based optical module (OMS) or by averaging over multiple pixels in a charge-coupled-device-based (CCD-based) OMS, The resulting spectral width is selected to be wider than the spectral width of the first filter transmission peak. The monitored signal therefore becomes the integrated intensity over the transmission peak.

The resulting transmission signal during the deposition of the subsequent cavities is then not sensitive to drifts in wavelength, centering between the transmission of the monitoring signal (i.e., from the first filter) and the actual filter transmission, as long as the drift is smaller than the monitored spectral width. Thus, the subsequent cavities are naturally centered at the same wavelength as the first filter, since the monitored signal is continuously being filtered by the first cavity,

The resulting transmission signal during the deposition of the subsequent cavities maintains the turning points in the monitored signal at the correct stopping points for the coating layers, so that the typical error correction of standard turning point monitoring is preserved.

With the disclosed self-filtering approach to optical monitoring, optical filters with a narrower spectral bandwidth than the resolution of the monitored signal can be formed, thus allowing use of CCD-based OMS monitoring with limited resolution instead of narrow spectral bandwidth single-wavelength OMS monitoring. This enables a CCD-based OMS to both have the advantages of broadband monitoring of multiple wavelengths, as well as being able to use classical turning point monitoring techniques of very narrow bandpass filters, which is normally limited to single wavelength OMS systems.

The following simple functional formula is an alternate to classical turning point monitoring and can be used to define the transmission signal as a function of time, and provides a fairly accurate estimate of when a layer is sufficiently thick and when the subsequent layer should be deposited:

$$T ( t ) = \frac{{T}_{0} [ B - 1 ]}{[ B - cos ( π R ( t + {t}_{0} ) ) ]}$$

where:

B is a fitting constant determining the amplitude of the transmission

T₀ is the peak transmission,

R is the deposition rate in QWs /sec and

t₀ is an offset factor.

In the above modified turning point monitoring equation, all four factors are used as fitting factors and the end point of each layer is determined by the turning point of the function, independent of the actual spectral width of the optical monitoring.

A new end point module was developed implementing the modified turning point monitoring equation (above) and spectral averaging over multiple CCD pixels. This module was used to deposit a narrow bandpass three-cavity filter using the feedback light from the first cavity; thus, two cavities were depositing using the filtered feedback light. The deposition was done in a Spector Ion Beam Deposition system and was monitored with a. “Quest” CCD-based OMS available from Veeco Instruments Inc. The resulting filter had a 0.6 nm full width at half maximum (FWHM). The spectral resolution of the Quest CCD-based ISIS was 1.5 nm, significantly broader than the FWHM of the deposited filter.

As a comparison, the same design was made with standard endpoint methods, i.e., with classical turning point monitoring. The result was a total collapse of the transmission peak and with no detectable transmission of the bandpass.

FIG. 4 is a graphical comparison of the theoretical transmission as calculated when not resolution limited to the actual transmission for individual layers of a narrow bandpass filter prepared by using 2.0 nm filtered feedback light to deposit the layers. As can be seen in FIG. 4, three cavities were deposited, each cavity being represented by a trough in the curve. The curve between each maximum and minimum of the curve represents a layer, so that at each maximum and minimum is an interface between two layers.

The first cavity of the three was formed using standard turning point control. Because the spectral width of the first cavity filter by itself was wider than the spectral width of the CCD-based OMS, the monitored signal behaved similar to expected theoretical behavior for most of the deposition. As seen in FIG. 4, some deviation from theory manifested itself in the last layers of the first cavity, These layers where therefore deposited based on the average rate measured with the OMS during the deposition of the preceding layers.

For the second and third troughs or cavities, the new end point module was used and the signal was integrated over a 2.5 nm spectral width.

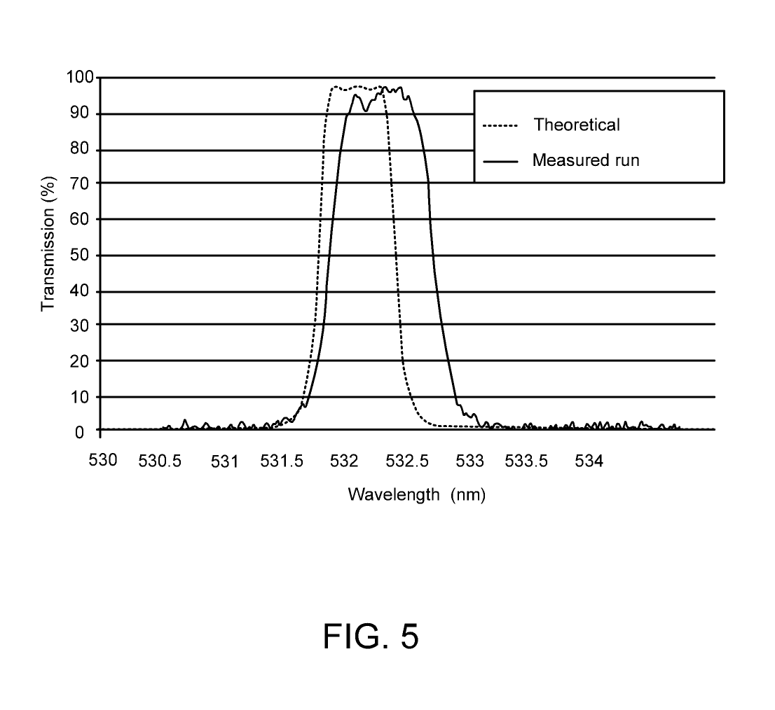

The spectral transmission for the resulting three-cavity filter is shown in FIG. 5, compared to a theoretical transmission for the design. As can be seen, although the measured transmission curve is shifted to slightly higher wavelengths than theoretical (about 0.5 nm higher wavelength than theoretical) and the measure transmission curve has a slightly wider band, the actual transmission was very close to the theoretical transmission. Some transmission noise was evident in the blocked wavelengths for the actual transmission, however this amount is negligible and does not substantively affect the function of the narrow bandpass filter.

FIG. 5 shows that an accurate, multiple-cavity narrow bandpass filter can be readily made by using light filtered through the previous cavities of the filter.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “lower”, “upper”, “beneath”, “below”, “above”, “on top”, etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the recited claims

What is claimed is:

1. A method of making a multi-cavity optical filter comprising multiple layers by monitoring feedback light filtered by an initially deposited first cavity to control the deposition of subsequent deposited layers.

2. The method of claim 1, wherein the monitored feedback light is integrated over a full spectral width of a transmission peak of the initially deposited first cavity.

3. The method of claim 2, wherein maximum and minimum of the monitored feedback light are used to determine stop points of each layer.

4. The method of claim 2, wherein the functional form:
$$T ( t ) = \frac{{T}_{0} [ B - 1 ]}{[ B - cos ( π R ( t + {t}_{0} ) ) ]}$$
is used to fit the monitored feedback signal during deposition to determine a stop point for the deposited layer, where:
B is a fitting constant determining the amplitude of the transmission signal,
T₀ is the peak transmission,
R is the deposition rate in QWs/sec, and
t₀ an offset factor.

5. The method of claim 2, where the monitored feedback light is integrated over multiple pixels in CCD-based monochromator corresponding to a spectral width wider than a spectral transmission width of the initially deposited first cavity.

6. The method of claim 5, wherein maximum and minimum of the monitored feedback light are used to determine stop points of each layer.

7. The method of claim 5, wherein the functional form:
$$T ( t ) = \frac{{T}_{0} [ B - 1 ]}{[ B - cos ( π R ( t + {t}_{0} ) ) ]}$$
is used to fit the monitored feedback signal during deposition to determine a stop point for the deposited layer, where:
B is a fitting constant determining the amplitude of the transmission signal,
T₀ is the peak transmission,
R is the deposition rate in QWs/sec, and
t₀ is an offset factor.

8. The method of claim 2, where the monitored feedback light is integrated by using a monochromator with a broader spectral resolution than the full spectral width of the initially deposited first cavity.

9. The method of claim 8, wherein maximum and minimum of the monitored feedback light are used to determine stop points of each layer.

10. The method of claim 8, wherein the functional form:
$$T ( t ) = \frac{{T}_{0} [ B - 1 ]}{[ B - cos ( π R ( t + {t}_{0} ) ) ]}$$
is used to fit the monitored feedback signal during deposition to determine a stop point for the deposited layer, where:
B is a fitting constant determining the amplitude of the transmission signal,
T₀ is the peak transmission,
R is the deposition rate in QWs/sec, and
t₀ an offset factor.

11. The method of claim 2, where the monitored feedback light is integrated by using a previously deposited optical filter with a larger spectral width than the spectral width of the initially deposited first cavity.

12. The method of claim 11, wherein maximum and minimum of the monitored feedback light are used to determine stop points of each layer.

13. The method of claim 11, wherein the functional form:
$$T ( t ) = \frac{{T}_{0} [ B - 1 ]}{[ B - cos ( π R ( t + {t}_{0} ) ) ]}$$
is used to fit the monitored feedback signal during deposition to determine the stop point for the currently deposited layer, where:
B is a fitting constant determining the amplitude of the transmission signal,
T₀ is the peak transmission,
R is the deposition rate in QWs/sec, and
t₀ is an offset factor.

14. A method of making an optical filter by depositing a set of layers based on filtered feedback light from an initial deposited optical filter.

15. The method of claim 14, wherein the depositing comprises monitoring a thickness of the set of layers based on the filtered feedback light.

16. The method of claim 15, wherein the monitoring is turning point monitoring.

17. The method of claim 16, wherein the turning point monitoring signal is fitted by:
$$T ( t ) = \frac{{T}_{0} [ B - 1 ]}{[ B - cos ( π R ( t + {t}_{0} ) ) ]}$$
where:
B is a fitting constant determining the amplitude of the transmission signal,
T₀ is the peak transmission,
R is the deposition rate in QWs/sec, and
t₀ is an offset factor.

18. A method of making an optical filter, comprising:
depositing a first set of layers to form a first cavity; and
depositing a second set of layers based on filtered feedback light from the first cavity to form a second cavity.

19. The method of claim 18, wherein the second cavity has a wavelength spectrum centered at essentially the same wavelength as the first cavity.

20. The method of claim 18, further comprising:
depositing a third set of layers based on filtered feedback light from the first cavity and the second cavity to form a third cavity.

21. The method of claim 20, wherein the third cavity has a wavelength spectrum centered at essentially the same wavelength as the first cavity and as the second cavity.

22. The method of claim 18, wherein the depositing a first set of layers and the depositing a second set of layers is done by the same process.

23. The method of claim 18, wherein the depositing a first set of layers and the depositing a second set of layers is done at the same temperature.

24. A method of making a narrow bandpass filter, the method comprising:
depositing a first dielectric layer on an initial optical filter, and monitoring a thickness of the first dielectric layer;
depositing a second dielectric layer on the first dielectric layer, and monitoring a thickness of the second dielectric layer;
wherein both the first thickness and the second thickness are monitored by fitting the measured transmission to the function:
$$T ( t ) = \frac{{T}_{0} [ B - 1 ]}{[ B - cos ( π R ( t + {t}_{0} ) ) ]}$$
where:
B is a fitting constant determining the amplitude of the transmission signal,
T₀ is the peak transmission,
R is the deposition rate in QWs/sec, and
t₀ is an offset factor.
